(19) United States
(12) Patent Application Publication
(10) Pub. No.: US 2005/0240420 A1
(43) Pub. Date: Oct. 27, 2005

(54) Real-time multimedia fishing tournament weigh-in data distribution system

(75) Inventors: Scott R. Iverson, La Crescent, MN (US); Jacob Sevlie, Bloomington, MN (US); Richard T. Mueller, Minneapolis, MN (US); Douglas Andersen, Plymouth, MN (US); Kirk Hemmen, Champlin, MN (US); William Petrowiak, Bloomington, MN (US); David Mahler, Minnetonka, MN (US); Douglas Chessor, Paducah, KY (US); Charlie Hoover, Bull Shoals, AR (US)

Correspondence Address: Merchant & Gould P.C., P.O. Box 2903, Minneapolis, MN, 55402-0903, US

(73) Assignee: Operation Bass, Inc.

(21) Appl. No.: 10/830,259

(22) Filed: Apr. 22, 2004

(51) Int. Cl. G06F 17/60

(52) U.S. Cl. 705/1

(57) ABSTRACT

A method and apparatus for providing a real-time multimedia fishing tournament weigh-in data distribution system over the Internet. The system includes a data detection module for detecting components of real-time multimedia fishing tournament data. A client module residing at a tournament site obtains and distributes multimedia fishing tournament data received from the data detection module to a server module via the Internet. The server module in turn processes and streams the processed real-time multimedia fishing tournament data to one or more users coupled to the Internet.

### TECHNICAL FIELD

This application relates in general to a data distribution system, and more particularly to a method and apparatus for providing a real-time multimedia fishing tournament weigh-in data distribution system over the Internet.

### BACKGROUND

Over recent years, professional fishing tournaments have increasingly become more popular with the public at large as sponsors have invested significant amounts of funds to use these events as part of their promotional activities for fishing related items. With the increase in popularity, the real-time delivery of the results from the tournaments to interested people located remotely from the tournament site has become a more important requirement for the tournament operators. The main point of interest for fans of these fishing tournaments is when the fish are being weighed-in at the end of the day. Typically, the fish are weighed-in at a central location with the fishermen being interviewed briefly as the fish weigh-in occurs. Once the fish have been weighed and the results are recorded, the next fisherman approaches the weigh-in location and the process repeats itself.

At present, there is no system that displays real-time weigh-in results and corresponding interviews of the fisherman. Remote viewers cannot access the on-going tournament results from any given day or the cumulative results over a multi-day tournament. These and numerous other disadvantages of the prior art necessitate the need for a real-time multimedia fishing tournament weigh-in data distribution system. The data from a large number of sources needs to be acquired, managed, and relayed back to the viewer over the Internet while delivering this data in real-time, or sufficiently close to real-time. The results can then be provided immediately to fans of the tournament via multimedia before any other data source can provide the information.

It can be seen that there is a need for real-time multimedia fishing tournament weigh-in data distribution system via the Internet.

### SUMMARY

This application relates in general to a method and apparatus for providing a real-time multimedia fishing tournament weigh-in data distribution system over the Internet.

A method for distributing real-time multimedia fishing tournament data in accordance with the principles of the present invention includes generating real-time multimedia fishing tournament data, transmitting the real-time multimedia fishing tournament data via Internet and receiving the real-time multimedia fishing tournament data at one or more user terminals.

In another embodiment of the present invention, a distribution system for real-time multimedia fishing tournament data in accordance with the principles of the present invention includes a real-time multimedia fishing tournament data detection module for generating real-time multimedia fishing tournament data, a client module coupled the real-time multimedia fishing tournament data detection module for transmitting the real-time multimedia fishing tournament data via the Internet, a server module coupled the client module for processing the real-time multimedia fishing tournament data, and one or more user terminals in communication with the server module for receiving the real-time multimedia fishing tournament data via the Internet.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

FIG. 1 illustrates an example embodiment for providing a real-time multimedia fishing tournament weigh-in data distribution system via the Internet according to the present invention;

FIG. 2 illustrates an example embodiment of a data display window that is part of a method and apparatus for distributing the real-time multimedia fishing tournament weigh-in data over the Internet according the present invention;

FIG. 3 shows an exemplary computing system that is operative to provide a programmable processing system according to one possible embodiment of the present invention;

FIG. 4 is a detailed illustration of real-time multimedia fishing tournament weigh-in data distribution system according to the present invention;

FIG. 5 is one embodiment illustrating the distribution or real-time fishing tournament weigh-in data over the Internet according to the present invention;

FIG. 6 is one possible architecture used in distributing the real-time fishing tournament weigh-in data over the Internet according to the present invention;

FIG. 7 is a flowchart illustrating one embodiment of the processing steps for a client distributing real-time fishing tournament weigh-in data over the Internet according to the present invention;

FIG. 8 is a detailed illustration of the streaming audio component of the real-time multimedia fishing tournament data according to the present invention; and

FIG. 9 is a detailed illustration of the streaming video component of the real-time multimedia fishing tournament data according to the present invention.

### DETAILED DESCRIPTION

This application relates in general to a method and apparatus for providing a real-time multimedia fishing tournament weigh-in data distribution system over the Internet. In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise. The term “connected” means a direct connection between the items connected, without any intermediate devices. The term “coupled” means either a direct connection between the items connected, or an indirect connection through one or more passive or active intermediary devices. The term “circuit” means either a single component or a multiplicity of components, either active and/or passive, that are coupled together to provide a desired function. The term “signal” means at least one current, voltage, or data signal. Referring to the drawings, like numbers indicate like parts throughout the views.

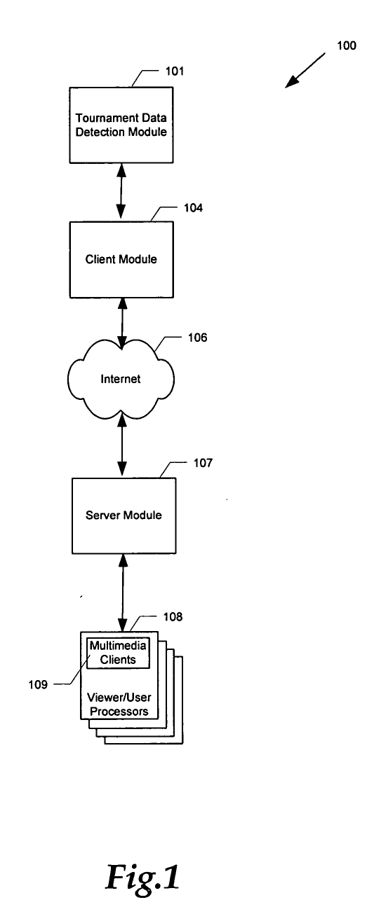

FIG. 1 illustrates an example embodiment for providing a real-time multimedia fishing tournament weigh-in data distribution system 100 via the Internet according to the present invention. The weigh-in for a fishing tournament is conducted at a remote site adjacent to the body of water used for the fishing event. A multimedia tournament data detection module 101 detects the weight-in data and multimedia data during interviews with the fishermen as the weigh-in occurs. A client module 104 collects the weigh-in and multimedia data and transmits the data to a web server module 107 for processing. More particularly, the client 104 generates web pages and similar data that are subsequently transmitted over the Internet 106 to the server module 107. The server module 107 processes and distributes the data to users 108 coupled directly to the server 107 or via users connected to the Internet 106. The users 108 further process the data using multimedia client applications 109.

In one embodiment of the invention, the multimedia data includes an audio version of an interview with a fisherman that occurs as his catch is being weighed-in. In alternate embodiments, other data such as streaming video, graphics, and similar data may be added in addition to or in place of the audio data stream. In transferring the multimedia data, the transfer capacity in the distribution system 100 from the remote weigh-in site where the data is detected 101 to the server module 107 is determined by the type of multimedia data communicated as well as the Internet transfer capacity to the viewers connected to the Internet 106. However, as the capacity of broadband Internet service increases, the ability to deliver greater quantities of multimedia data will increase.

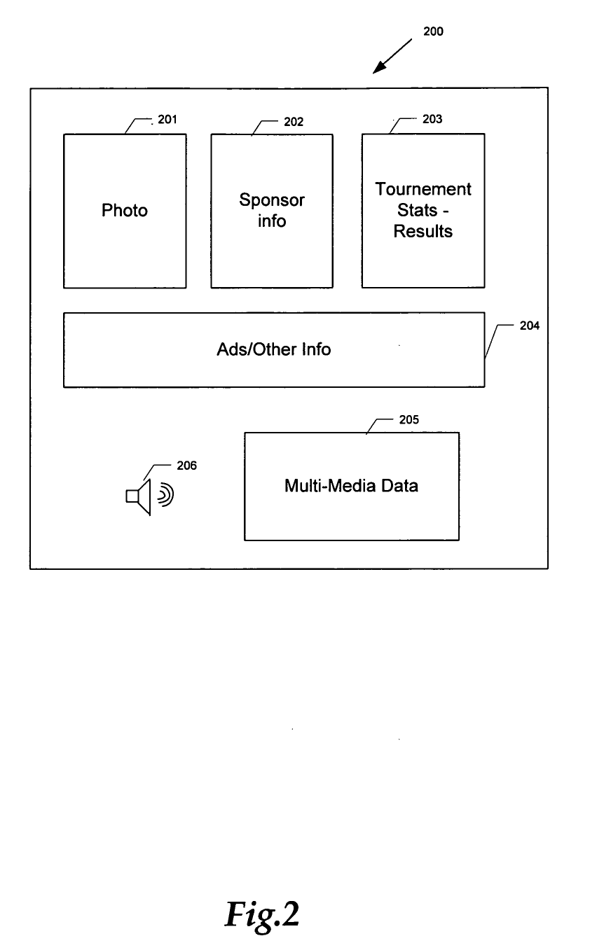

FIG. 2 illustrates an example embodiment of a data display window 200 that is part of a method and apparatus for distributing the real-time multimedia fishing tournament weigh-in data over the Internet according the present invention. Typically, an end user 108 receives and views data received over the Internet 106 using a web browser. The web browser is able to support numerous plug-ins that accept a variety of multimedia data formats.

The web page 200 typically includes scrollable regions of data that display a variety of different data items on the page 200. For the fishing tournament weigh-in, this data would typically include a photograph 201 or graphical representation of the fisherman interviewed and the fish being weighed at the weigh-in, tournament results and statistic data 203, sponsor 202, related advertisement information 204 for the tournament and/or the fisherman, and multimedia data 205 including an audio data stream 206. The sponsor 202 and advertisement information 204 may relate to the sponsors and the advertisers of the tournament, the fisherman, or both. When a particular fisherman is sponsored by an entity that has a business relationship with the tournament and/or the web site operator, data of interest to the sponsor may be displayed. Otherwise, generic information and/or data relevant to only the tournament is displayed.

The tournament results and statistics 203 can include the results from a given day or can include both a single day's results in addition to the cumulative total results for the tournament up to the present time. In one embodiment, the results can present the statistics 203 for the fisherman and the fish being weighed-in as well as the relationship of the fisherman to the rest of the competition. All of this data is collected and processed by a web server. The web server formats the data into coherent pages that are displayed to the viewers. The graphical/photographic data 201 can also be synchronized with the audio stream 206 and new tournament results data 203, appearing to a viewer as being received from a single source.

The user terminal 108 will provide control over which information is displayed and how that information is displayed. For example, in one possible embodiment, the statistics window 203 will display a current real-time listing of standings for a selected tournament. However, a user can select instant replay to view past information. The instant replay section will allow users to view any tournament participant that may or may not have already weighed-in. In one embodiment, the user can enter instant replay mode by selecting any name in any area of the display window 200. When the user is in instant replay mode, weigh-in data will continuously be fed to the user terminal 108. As a result, the user may miss some weigh-ins while in instant replay mode. However, the user will be able to view the missed records by selecting a name(s) in a history region of the display screen 200, such as in the other information area 204.

A user will be able to resume viewing the live tournament data, either by manually selecting a live feed tab or drop-down menu item. However, if the user takes no action for more than thirty seconds, the application will automatically return the user back to viewing the live feed from the tournament.

The user will also have the ability to search for any angler that is already in a database or in the history files. Using a keyboard, for example, the user begins to type the name of a desired angler. Display window application software will anticipate what a user is typing and finish the spelling for the user as the user types in a name. Pressing return/enter key on the keyboard of the user terminal will select the angler found. The user will also be able to cycle through other anglers by selecting the up or down arrow keys located on the user keyboard. However, the present invention is not limited to the above keyboard functionality and any suitable keyboard functionality can be utilized.

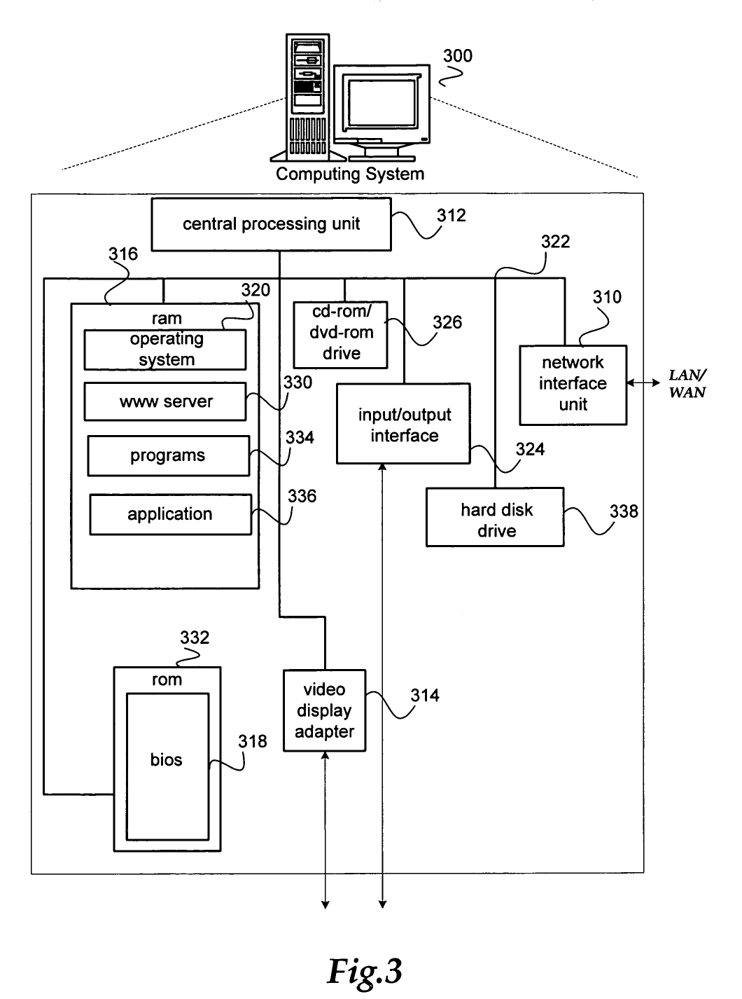

FIG. 3 shows an exemplary computing system 300 that is operative to provide a programmable processing system according to one possible embodiment of the present invention. In some applications, computing system 300 acts as a World Wide Web (web) server to transmit web pages to a web browser application program executing on requesting devices to carry out this process. For instance, a web server 300 may transmit pages and/or forms used for retrieving information from a user. In one embodiment, the form elicits such information as user preferences, address, telephone number, billing information, credit card numbers, and the like. Moreover, the web server 300 can transmit web pages to a requesting device and allow a user to interact with a web pages. The interaction can take place over the Internet, WAN/LAN, or any other suitable communications network.

The computing system 300 of the present invention is not limited to the above-mentioned components and can include many more components than those shown in FIG. 3. However, the components shown are sufficient to disclose an illustrative embodiment for practicing the present invention. For example, the computing system 300 is connected to a WAN/LAN, or other communications network, via network interface unit 310. Hence, it will be appreciated that the network interface unit 310 includes the necessary circuitry for connecting computing system 300 to WAN/LAN, and is constructed for use with various communication protocols including the TCP/IP protocol. Typically, the network interface unit 310 is a card contained within the computing system 300.

The computing system 300 also includes processing unit 312, video display adapter 314, and a mass memory, all connected via bus 322. The mass memory generally includes RAM 316, ROM 332, and one or more permanent mass storage devices, such as hard disk drive 338, a tape drive, CD-ROM/DVD-ROM drive 326, and/or a floppy disk drive. The mass memory stores operating system 320 for controlling the operation of the programmable computing system 300. It will be appreciated that this component may comprise a general-purpose server operating system such as UNIX, LINUX™, or Microsoft WINDOWS NT®. Basic input/output system (“BIOS”) 318 is also provided for controlling the low-level operation of computing system 300.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for providing a website. More specifically, the mass memory stores applications including a web server application program 330, support programs 334, and a real-time fishing tournament weigh-in data distribution application 336. Web server application program 330 includes computer executable instructions which, when executed by the system computer 300, generate web browser displays, including performing the logic described above. The computing system 300 may include a JAVA virtual machine, an SMTP handler application for transmitting and receiving email, an HTTP handler application for receiving and handing HTTP requests, JAVA applets for transmission to a web browser executing on a client computer, and an HTTPS handler application for handling secure connections. The HTTPS handler application may be used for communication with external security applications (not shown), to send and receive private information in a secure manner.

The computing system 300 also comprises input/output interface 324 for communicating with external devices, such as a mouse, keyboard, scanner, or other input devices not shown in FIG. 3. Likewise, computing system 300 may further comprise additional mass storage facilities such as CD-ROM/DVD-ROM drive 326 and hard disk drive 338. Hard disk drive 338 is utilized by computing system 300 to store, among other things, application programs, databases, and program data used by web server application program 330. For example, customer databases, product databases, image databases, and relational databases may be stored. The operation and implementation of these databases is well known to those skilled in the art.

In the generation of the web pages and related view display data, the data may be formatted into any number of data formats without deviating from the spirit and scope of the present invention. For many web pages, the use of HTML may be adequate; however, the multimedia data may be better provided in any number of data formats including Flash data in the format created and supported by Macromedia Corporation, QuickTime data in the format created and supported by Apple Computer, and Real Audio data in the format created and supported by Real Inc. The present invention is not limited the above-mentioned data formats and the choice of the multimedia data format, and its supporting server and client programs, is one of any suitable design choice with an alternate choices also falling within the spirit and scope of the present invention.

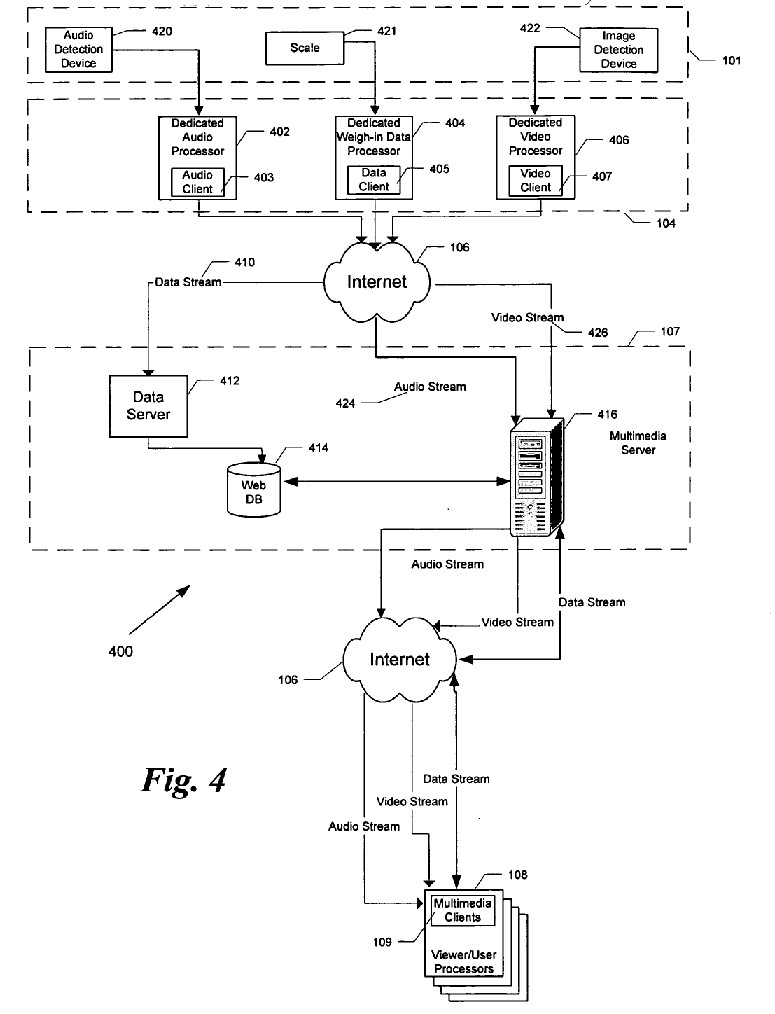

FIG. 4 illustrates is detailed illustration of a real-time multimedia fishing tournament weigh-in data distribution system 400 according to the present invention. In one embodiment of the data distribution system 400 a live weigh-in of a fish is broadcast from a tournament site. The broadcast multimedia data is made possible with the use of a dedicated audio processor 402 having an audio client application 403, a dedicated data processor 404 having a data client application 405, and a dedicated video processor 406 having an audio client application 407. Each dedicated device 402, 404, 406 is located at the fishing tournament site. The functionality for transferring the multimedia data to users will be explained in greater detail in the following paragraphs.

At the tournament site, a data detection module 101, coupled to the client module 104, detects the live weigh-in of a fish. The data detection unit 101 includes, but is not limited to, and audio detection device 420 such as a microphone, a weigh-in data detection device 421 such as a scale, and a video detection device 421 such as a camera.

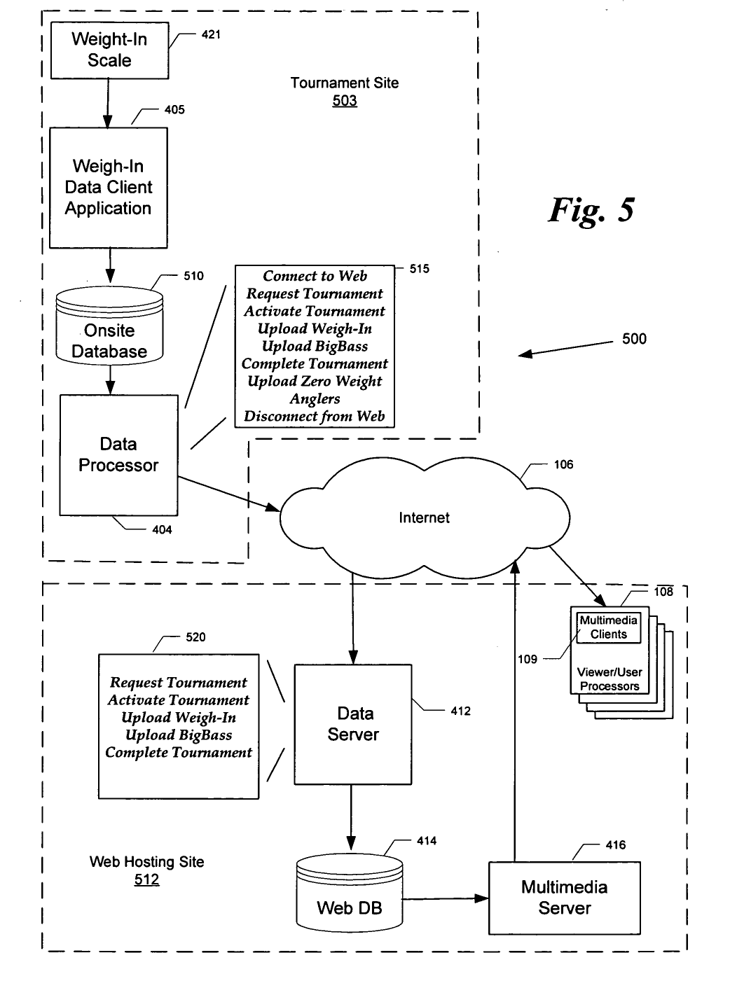

On a tournament stage, the fish is placed in the scale 421. The scale 421 is electronically coupled to a dedicated data processor 404. Software executing on the dedicated data processor 404 stores the weigh-in data recorded by the scale 421 into an on-site database, which will be explained in greater detail in FIG. 5. The stored weigh-in data is then transmitted by the client application 405 executing on the dedicated data processor 404 via a communication port, for example, a serial input port.

The dedicated data processor 404 is coupled to the Internet 106. Data stored in the on-site database by the dedicated data processor 404 is streamed 410 to the server module 107. The server module 107 may be located at any suitable facility, such as a website hosting facility. The server module 107 includes, but is not limited to, a data server 412, a web database 414 and a multimedia server 416. The data server 412 is continuously updating the web database 414 with weigh-in data in real-time from the fishing tournament site.

The multimedia server 416, such as a flash communication server, will continuously check for new multimedia data. An application executing on the multimedia server 416 will download new data to any connected users 108 via the Internet 106. New multimedia data includes, but is not limited to, weigh-in data stored in the web database 414 and streaming data from the dedicated audio processor 402 and dedicated video processor 406. The multimedia server 416 will notify any connected users 108 as the multimedia data becomes available.

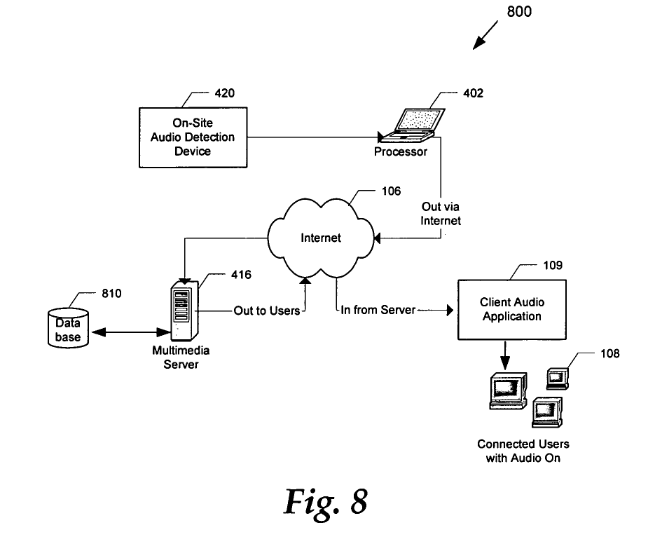

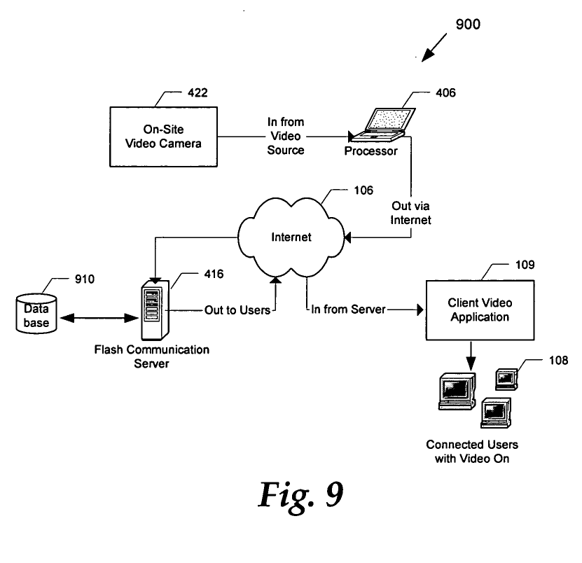

In one possible embodiment, audio input detected by an audio detection device 420 is input to the dedicated audio processor 402. The audio client application 403 executing on the dedicated audio processor 402 transmits an audio stream 424 detected by the audio detection device 420 to the multimedia server 416. Once the multimedia server 416 receives the audio stream 424, the multimedia server 416 streams the audio data 424 to all users 108 coupled to the multimedia server 416 and configured to receive the audio stream 424. The multimedia server 416 will also stores a copy of the audio stream on a disk internal or external to the multimedia server 416. The disk will be discussed in greater detail with FIGS. 8 and 9.

In another embodiment, streaming video data 416 is simultaneously processed along with the streaming audio data 424 and streaming weigh-in data 410. Video input detected by a video detection device 422 is input to the dedicated video processor 406. The video client application 407 executing on the dedicated video processor 406 transmits the video stream 426 detected by the video detection device 420 to the multimedia server 416. Once the multimedia server 416 receives the video stream 426, the multimedia server 416 streams the video data 426 to all users 108 coupled to the multimedia server 416 and configured to receive the video stream 426. The multimedia server 416 will also stores a copy of the video stream 426 on a disk internal or external to the multimedia server 416.

The distribution system 400 is an automated process that only needs to be started at the beginning of a weigh-in tournament. The multimedia server 416, such as a flash communication server, allows for data to be requested and stored locally on the server 416 instead of many queries being made to the client 403, 405, 407. The advantage of the multimedia server 416 over file transfer protocols (FTP), for example, is its ability to stream real time audio and video data along with weigh-in data. This processing of the multimedia server 416 is faster and not suspect to foul corruption as detected in the file transfer protocols (FTP).

The multimedia server 416 processing is also faster. The process from the weigh-in at the scale 421 to the web database 414 has a minimum delay of approximately 1 second and a maximum delay of approximately 3.5 seconds. Once data has been stored in the web database 414, there is delay of approximately 1-5 seconds before the data reaches a client application 109 residing at the user 108. In one possible embodiment, multimedia server 416/client application 109 interface is built on a technology such as Flash technology allowing the user to easily control his or her browser environment. The following discussion will describe the audio, video and weigh-in components of the distribution system 400 in greater detail.

FIG. 5 is one embodiment 500 illustrating the distribution or real-time fishing tournament weigh-in data over the Internet according to the present invention. The processing associated with this embodiment of the invention begins with a fish being weighed-in at a scale 421 at, for example, the tournament site 503. A client data application 405 executed by a processor 404 at the tournament site 503 is coupled to the scale 421. Weigh-in data, measured by the scale 421, is stored in an on-site database 510 attached to the processor 404. In one embodiment, the weigh-in data client application 405, onsite database 510, and data processor 404 is one unit. However, the present invention is not limited to the above components 405, 510, 404 being configured as one unit, and any suitable convention can be used, such as the data client application 405 being executed on another remote or local processor and the on-site database 510 being a remote database.

The weigh-in data is then transmitted to the web-hosting site 512 and received by users or viewers 108 via the multimedia client application 109. In operation, at the web-hosting site 512, a user 108 can connect to one or more tournaments located at different tournament sites 503. Accordingly, a user 108 that is coupled to the Internet 106 simply selects which tournament(s) the user 108 would like to view. By selecting a tournament(s), the weigh-in client application 405 will automatically execute multiple functions as discussed in accordance with the data client 404 and the data server 412 below.

In one possible embodiment the data client 404 and data server 412 is implemented by any suitable architecture, such as a common object request broker architecture (CORBA), which will be discussed in greater detail below. The data client 404 resides at the tournament sites 503. The function of the data client 404 is to interact with the data server 412 through the Internet 106, sending weigh-in data for processing at the web-hosting site 512. The operations 515 the data client 404 performs, but is not limited to, include connecting to the Internet 106, requesting tournament(s), activating tournament(s), uploading weigh-ins, uploading any additional data (e.g., Big Bass: tournament data with respect to Bass fishing), completing the tournament(s), upload zero weight anglers (anglers that do not participate), and disconnecting from the Internet 106. However, the present invention is not limited to the data client 404 residing at the tournament site 503 and the data client 404 may reside at any suitable location locally or remotely coupled to the data detection device 421 at a tournament site 512.

The data client 404 can interact with a graphical user interface (GUI) at the tournament site 503, such as a GUI executing on the dedicated weigh-in data processor 404. However, the GUI can merely be a lightweight informational display or any other suitable display. At the data client 404, a user's only interaction with the GUI will be a selection of the tournament the user desires to run during at startup at the tournament site 503. The data client 404 then transmits tournament weigh-in data across the Internet 106 to a web data server 412. The web server populating a web database 414 which is operated o by a multimedia server 416.

A server application program will execute on the data server 412 at the web-hosting site 512. The function or the server application program is to listen for requests from the data client 404 and execute received requests within a secured server environment. The operations 520 the data server 412 performs include, but are not limited to, requesting tournament(s), activating tournament(s), uploading weigh-ins, uploading any additional data (e.g., Big Bass), and completing the tournament(s).

In one embodiment, at the startup of the data client application 405, the data client 404 will verify an Internet connection. If the Internet 106 is unavailable, the data client application 405 will try to connect to the Internet 106 using dial-up networking. Once connected, the data client 404 will request the available tournaments from the data server 412 and populate a drop-down box on, for example, the GUI. The user can then select which tournament will be executed. Once a tournament is selected, the user will simply select “Start” on the GUI to begin the processing. The data client 404 will notify the data server 412 to activate the tournament and the data client 404 will begin to send weigh-in data once weigh-in data becomes available. In one embodiment, all executing processes can be logged to a process log.

During the processing of weigh-in data at the tournament site 503, all information sent to the data server 412 will be logged to a weigh-in log text box on the GUI screen at the data client 404. This will allow the user/operator at the GUI to view the actual data being sent over the Internet 106.

The data server 412 receives the data from the data client 404 and the data server 412 updates the data within the web server database 414. Once the data is located within the web server database 414, the viewer's client application 109 requests the new data from the web database 414 via the multimedia server 416. The multimedia server 416 allows for requested weigh-in data to be stored locally on the multimedia server 416, or other local or remote server. The multimedia server 416 also provides the ability to stream the live multimedia data to the users 108. For example, in one alternate embodiment, the viewer's client application 109 is a Flash application modules executing on a viewer's computer 108. This alternate embodiment for the invention increases the automatic update for the data viewed by end users 108 while supporting a more varied and rich multimedia data environment while providing constant and more reliable data updates.

Once the data client 404 detects there is no more data to process, a message will be sent to the data server 412 to complete the tournament and zero-weight anglers will be uploaded. Finally, the Internet connection will be closed. The user will be able to view the logs on the GUI until the data client application 405 is closed. To exit the data client application 405, the user will select “Exit” on the GUI.

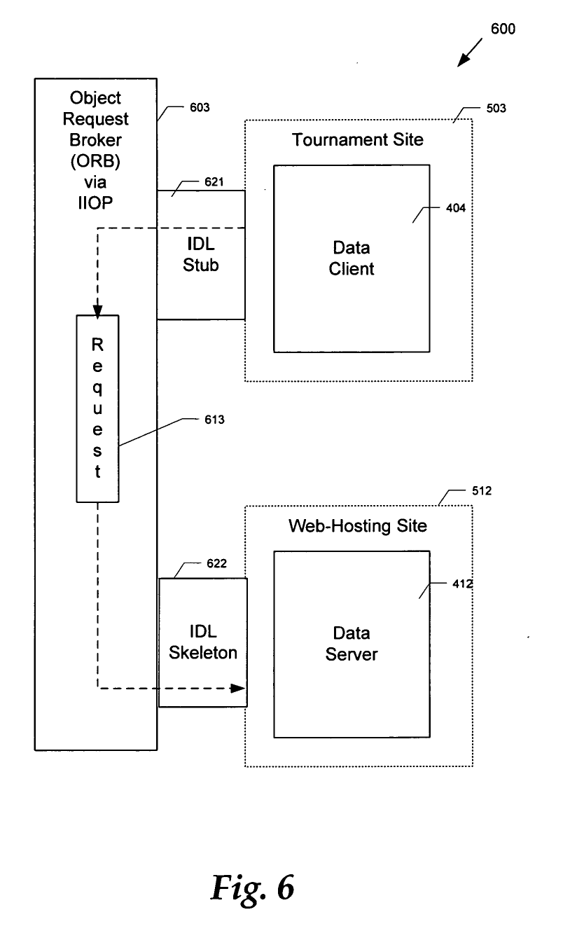

FIG. 6 is one possible architecture 600 used in distributing the real-time multimedia fishing tournament weigh-in data over the Internet according to the present invention. As discussed above, one possible architecture used in the real-time multimedia fishing tournament weigh-in data distribution system is a CORBA (Common Object Request Broker Architecture) architecture. However, the present invention is not limited to the CORBA architecture and any suitable architecture for transferring data between a client and a server can be used.

As mentioned above, in the client/server application of the present invention, the data server 412 provides distributed methods for data clients 404 to send tournament data to the Internet 106. As such, data client applications 405 located at the tournament sites 503 can obtain and send the weigh-in data as it is generated to a web data server 412 residing at the web-hosting site 512. The data client 404 obtains and transmits the weigh-in data and any other desired information, including multimedia data, to the data server 412. The data client 404 accesses the weigh-in data from the on-site database 510 and utilizes methods published by the data server 412 to transmit the weigh-in and other data to web data server 412 via the Internet 106. The web data server 412 can then, in turn, update its data and transmit the updated data to multimedia client applications 109 of the users/viewers 108. In one possible embodiment, both the data client application 405 and the application for data server 412 can be built using CORBA, JAVA, and JDK 1.4 ORB protocols.

In one embodiment a data client 404, such as a CORBA client, monitors the state of the weigh-in data within the on-site database 510 to determine if any new data has been added. When the data client 404 determines data has been added to the database 510, it obtains the new data and transfers the data to the web data server 412, such as a JAVA CORBA server, via an Internet InterOrb protocol (IIOP). This use of the standard data transfer protocol is discussed in more detail below. However, any other data transfer protocol may be used without deviating from the spirit and scope of the present invention as recited within the attached claims.

CORBA modules provide a framework for building and deploying distributed systems according to the present invention. This protocol combines object oriented programming software development methodology and client/server processing to obtain a desired processing system. This approach permits a development process that will abstract out much of the complicated network programming needed to build a distributed application. CORBA is a well known and standardized protocol that is used in numerous distributed processing systems.

The components of the architecture 600 used to provide communication between the tournament site 503 and the web-hosting site 512 include a pair of interface definition language (IDL) modules 621-622 and an object request broker (ORB) 603. The architecture 600 also includes a set of callable methods used by the data client 404 for each operation to transfer and load generated data onto the Internet 106.

The IDL module pairs, which are included in every CORBA distributed application, include an IDL stub 622 and an IDL skeleton 621 along with other generated files. Using a single IDL file and an IDL compiler generates these files. The IDL describes the interfaces, for example, that client objects call and that server objects provide to perform data transfer operations.

The ORB module 603 is used to simply connect clients requesting services 613 to server objects providing the requested services. An Internet InterORB Protocol (IIOP) is the standard protocol that the ORB module 603 utilizes to provide data communication between, for example, the data client 404 and the data server 412.

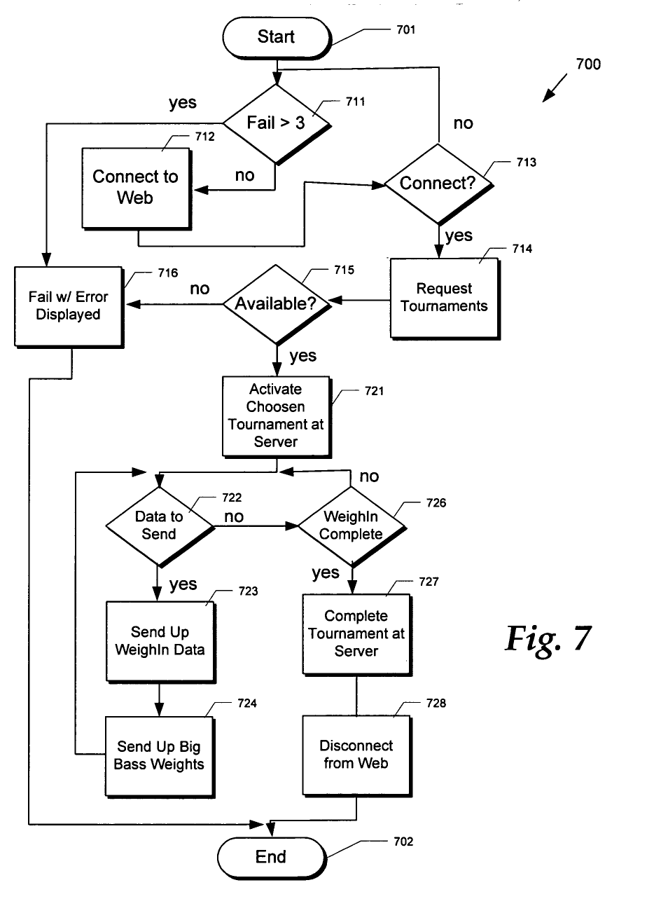

FIG. 7 is a flowchart 700 illustrating one embodiment of the processing steps for a client distributing real-time fishing tournament weigh-in data over the Internet according to the present invention. The processing starts 701 and proceeds through a processing loop defined by a test module 711. The processing loop provides a threshold value to limit the attempts to connect to the Internet 712. If a first attempt to connect to the Internet 713 is not successful, additional attempts to connect to the Internet will be executed. If the number of unsuccessfully attempts exceeds the threshold, such as a threshold of 3 attempts, an error is displayed 716 and the processing ends 702.

If the process successfully connects 713 to the Internet, the available tournaments can be requested 714. If a requested tournament is not available, decision module 715 determines this error and directs the processing again to module 716 to inform the user of the error before the processing ends 702. If the requested tournament is available, the processing proceeds to module 721 where the chosen tournament is activated at the server. The client module then remains in a waiting loop defined by the two test modules 722 and 726. Test module 722 determines if data is available to be sent. If not, test module 726 determines if the weigh-in process is complete. If not, the process continues in the loop until either data is present and can be sent or until the weigh-in process is complete.

When data is available to be sent, test module 722 directs the processing to module 723. This module 723 transfers the data to the server application using an above-described protocol. Next, module 724 transfers any data, such as Big Bass weight data, to the server and the processing then returns to the test module 722-726 waiting loop.

When test module 726 determines that the weigh in process is complete, the processing proceeds to module 727 to complete the operations of the tournament application on the server. The client application then disconnects from the Internet in module 728 before the processing ends 702.

FIG. 8 is a detailed illustration 800 of the streaming audio component of the real-time multimedia fishing tournament data according to the present invention. In general, streaming audio data detected by an audio detection device 420 is transmitted and processed by users 108. A computer processor 402, such as a dedicated audio laptop, is coupled to an audio detection device 420, such as a microphone. Sound detected by the audio detection device 420 is processed by a client application 109, such as a Flash MX audio broadcasting application. The client application 109 can be executing on the user terminal 108 or executing any other suitable device locally remotely located.

Operationally, the dedicated audio processor 402 coupled to the audio detection device 420 is connected to the Internet 106 using a universal resource locator (URL). Once the connection is made to the URL, all audio data detected at the tournament site 503 is automatically streamed (automatically broadcast) easily through the Internet 106 to the multimedia server 416, such as a Flash Communication Server MX. At this point, the audio will be saved to a database 810 and simultaneously be streamed to the users 108 listening to the tournament. A client application 109 executing on a user terminal 108, such as a Flash MX audio broadcaster application, and in communication with the server 416 can listen or utilize the streaming audio input from the communication server 416.

The user terminal 108 has the capability to control the audio stream. The user terminal, as well as an operator at the tournament site 503 or in a remote location, can stop, start or format the audio data stream. In formatting the audio data stream, a user 108 can, but is not limited to, select where the incoming audio data in output, e.g., a first or second set of speakers. The user 108 can also respond audibly, for example, to received audio information. The response information from the user 108 will be stored in the web database 414 and/or processed by an operator acting on the web database 414.

FIG. 9 is a detailed illustration 900 of the streaming video component of the real-time multimedia fishing tournament data according to the present invention. In general, streaming video data detected from and image detection device 422 is transmitted and processed by users 108. A computer processor 406, such as a dedicated video laptop, is coupled to an image detection device 422, such as a web cam. Images detected by the image detection device 422 are processed by a client application 109, such as a Flash MX video broadcasting application. The client application 109 can be executing on the user processor 108 or be executed any other suitable device locally or remotely located.

Operationally, the dedicated video processor 406 coupled to the image detection device 422 is connected to the Internet 106 using a universal resource locator (URL). Once the connection is made to the URL, all video data detected at the tournament site 503 is automatically streamed (automatically broadcast) easily through the Internet 106 to the multimedia server 416, such as a Flash Communication Server MX. At this point, the video will be saved to a database 910 and simultaneously be streamed to the users 108 watching the tournament. A client application 109 executing on a user terminal 108, such as a Flash MX video Broadcaster application, and in communication with the multimedia server 416 can watch or utilize the streaming video input from the communication server 416.

The user terminal 108 has the capability to control the video stream. The user terminal, as well as an operator at the tournament site 503 or in a remote location, can stop, start or format the video data stream. In formatting the video data stream, a user 108 can, but is not limited to, select where the incoming video data is output to the display (see FIG. 2), e.g., characteristics of the font and display background. The user 108 can also respond by sending video images to the multimedia server 416 to be stored in the web database 414 and/or processed by an operator acting on the web database 414.

The operating environment for the distribution system mentioned above is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, held-held or other laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired in various embodiments.

Also, processing devices attached to a communications network typically includes at least some form of computer readable media. Computer readable media can be any available media that can be accessed by these devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by processing devices.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Additionally, the embodiments described herein are implemented as logical operations performed by programmable processing devices. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method for distributing real-time multimedia fishing tournament data, comprising:
generating real-time multimedia fishing tournament data;
transmitting the real-time multimedia fishing tournament data via Internet; and
receiving the real-time multimedia fishing tournament data at one or more user terminals.

2. The method of claim 1, wherein generating the real-time multimedia fishing tournament data further comprises receiving weigh-in data from a scale and transmitting the weigh-in data by a computer processor.

3. The method of claim 2 further comprising storing the weigh-in data in a local database.

4. The method of claim 1, wherein transmitting the real-time multimedia fishing tournament data further comprises transmitting weigh-in data stored in a local database.

5. The method of claim 4, wherein transmitting the weighed-in data stored in the database further comprises:
polling the local database for new weigh-in data by a data client;
transmitting the new weigh-in data stored in the local database to a data server; and
storing the new weigh-in data in a web database by the data server.

6. The method of claim 5, wherein transmitting the data to the data server further comprises transmitting the weigh-in data via the Internet to the data server using a common object request broker.

7. The method of claim 1, wherein transmitting the real-time multimedia fishing tournament data further comprises transmitting real-time video and audio data.

8. The method of claim 1, wherein transmitting the real-time multimedia fishing tournament data further comprises simultaneously transmitting the real-time video, audio and weigh-in data via the Internet.

9. The method of claim 1, wherein transmitting the real-time multimedia fishing tournament data further comprises providing the multimedia data to a multimedia server, wherein the multimedia server is in communication with the one or more user terminals.

10. The method of claim 9, wherein providing the multimedia fishing tournament data further comprises polling a web database for weigh-in data by the multimedia server.

11. The method of claim 1, wherein receiving the real-time multimedia fishing tournament data at one or more user terminals further comprises controlling the multimedia fishing tournament data by the one or more user terminals.

12. The method of claim 11, wherein controlling the multimedia fishing tournament data further comprises starting, stopping and formatting the stream of multimedia fishing tournament data.

13. The method of claim 1 further comprising providing a multimedia client executing on the one or more user terminals, the multimedia client being in communication with a multimedia server for sending and receiving data.

14. The method of claim 13, wherein sending an receiving data further comprises sending data to and receiving weigh-in data from a web database.

15. The method of claim 14 further comprising accessing the web database by an operator for retrieving and processing information received by the one or more user terminals.

16. A distribution system for real-time multimedia fishing tournament data, comprising:
a real-time multimedia fishing tournament data detection module for generating real-time multimedia fishing tournament data;
a client module, coupled the real-time multimedia fishing tournament data detection module, for transmitting the real-time multimedia fishing tournament data via the Internet;
a server module, coupled the Internet, for receiving and processing the real-time multimedia fishing tournament data; and
one or more user terminals in communication with the server module for receiving the real-time multimedia fishing tournament data.

17. The distribution system of claim 16, wherein the client module further comprises one or more processors, each of the one or more processor transmitting one or more component of the real-time multimedia fishing tournament data detected by the detection module.

18. The distribution system of claim 17, wherein each of the one or more processor further comprises a client for transmitting the real-time multimedia fishing tournament data over the Internet.

19. The distribution system of claim 16, wherein the client module further comprises data detection devices for detecting the components of the real-time multimedia fishing tournament data, the data detection devices including
a scale for detecting a weigh-in data component;
an audio detection device for detecting an audible sound component; and
a video detection device for detecting a video image component.

20. The distribution system of claim 16 further comprising a local database coupled to the client module for storing the weigh-in data before the transmission via the Internet.

21. The distribution system of claim 16, wherein the server module is coupled between the client module and the one or more user terminals for transferring data between the client module and the one or more user terminals.

22. The distribution system of claim 19, wherein the client module further comprises
an data processor coupled to the scale for transmitting the weigh-in data component;
an audio processor coupled to the audio detection device for transmitting the audible sound component; and
a video processor coupled to the video detection device for transmitting the video image component.

23. The distribution system of claim 19, wherein the server module further comprises a data server for receiving real-time weigh-in data from the client module; and
a multimedia server for transmitting the real-time multimedia fishing tournament data received from the client module to the one or more user terminals.

24. The distribution system of claim 23, wherein the data server is coupled to a web database for storing the weigh-in data from the client module.

25. The distribution system of claim 16, wherein a common object request broker architecture is used to transmit real-time weigh-in data between the client module and the server module.

26. The distribution system of claim 16, wherein the one or more user terminals further comprises a multimedia client executing on the one or more user terminals for receiving the real-time multimedia fishing tournament data form the server module and controlling the real-time multimedia fishing tournament data.

27. The distribution system of claim 26, wherein the multimedia client controls starting, stopping and formatting a stream of real-time multimedia fishing tournament data.

28. The distribution system of claim 26, wherein the multimedia client being in communication with the multimedia server for sending and receiving data.

29. The distribution system of claim 26, wherein the multimedia client being in communication with the multimedia server for sending data to and receiving data from a web database.

30. The distribution system of claim 29, wherein the web database is accessed by an operator for retrieving and processing information received by the one or more user terminals.

31. The distribution system of claim 16, wherein the one or more user terminals are in communication with the server module for receiving the real-time multimedia fishing tournament data via the Internet.
